(19) United States
(12) Patent Application Publication
(10) Pub. No.: US 2026/0308866 A1
(43) Pub. Date: Oct. 8, 2026

(54) BELOW GRADE WATERPROOFING MEMBRANE

(71) Applicant: GCP Applied Technologies Inc., Malvern, PA (US)

(72) Inventors: David Lee Cozzens, Burlington, MA (US); Xia Cao, Acton, MA (US); Jyoti Seth, Andover, MA (US)

(21) Appl. No.: 19/637,892

(22) Filed: Apr. 2, 2026

Related U.S. Application Data
(60) Provisional application No. 63/782,750, filed on Apr. 3, 2025.

(51) Int. Cl. E02D 31/02; B32B 7/06; B32B 7/12; B32B 27/08; B32B 27/32; B32B 27/36; E02D 17/20

(52) U.S. Cl. CPC E02D 31/02; B32B 7/06; B32B 7/12; B32B 27/08; B32B 27/32; B32B 27/36; E02D 17/202; B32B 2250/03; B32B 2307/7242; B32B 2307/726; B32B 2307/7265

(57) ABSTRACT

In one aspect a waterproofing article includes: a first layer, the first layer being impermeable to an injection fluid; an adhesive layer disposed over at least a portion of the first layer; a second layer disposed over at least a portion of the adhesive layer, the second layer being permeable to the injection fluid; and a third layer disposed over the second layer, the third layer being permeable to the injection fluid; and wherein the waterproofing article further exhibits or includes at least one of the following: the adhesive layer is disposed over at least 50% of the surface area of the first layer; the adhesive layer comprises a pressure sensitive adhesive; the first layer comprises a multilayer film; the first layer comprises a methane barrier layer; and the first layer exhibits a maximum or steady-state permeation rate to reagent grade chlorinated hydrocarbons below 10000 μg/cm²/min at a temperature of 60° C. measured according to ASTM F739 Open Loop method.

### CROSS-REFERENCE TO RELATED APPLICATION(S)

This Application claims priority under 35 U.S.C. § 119(e) to U.S. Provisional Patent Application No. 63/782,750, entitled “BELOW GRADE WATERPROOFING MEMBRANE,” filed on Apr. 3, 2025, by David Lee COZZENS et al., which is assigned to the current assignee hereof and is incorporated herein by reference in its entirety.

### FIELD OF THE DISCLOSURE

The present invention relates to waterproofing membranes for below grade waterproofing applications, waterproofing systems for shotcrete and methods in building and construction.

### BACKGROUND

The present invention relates to a waterproofing membrane for post-installation in-situ barrier creation, and more particularly to a waterproofing membrane for providing a medium for post-installation injection of remedial substances such as waterproofing resins or cements or grouts, insecticides, mold preventatives, rust retardants, and the like.

It is common in underground structures, such as tunnels, mines, and large buildings with subterranean foundations, to require that the structures be watertight. Thus, it is essential to prevent groundwater from contacting the porous portions of structures or joints, which are typically of concrete. In pre-applied blindside waterproofing, the waterproofing membrane is typically mechanically fastened (stapled) to wood lagging. The punctures through the waterproofing membrane from mechanical fasteners is a potential point of water ingress and is typically addressed by covering over punctures with a patch of tape. For a groutable waterproofing membrane, a tape is unsuitable because it obstructs grout transmission through the concrete-facing side of the waterproofing membrane.

Hence, there is a need for a waterproofing membrane that provides seal around punctures thereby producing a continuous primary waterproof barrier, and a secondary waterproofing barrier for injecting grout that is activated on demand.

### SUMMARY

This summary is provided to introduce a selection of concepts that are further described below in the detailed description. This summary is not intended to identify indispensable features of the claimed subject matter, nor is it intended for use as an aid in limiting the scope of the claimed subject matter.

In one aspect a waterproofing article comprises:
a first layer, the first layer being impermeable to an injection fluid;
an adhesive layer disposed over at least a portion of the first layer;
a second layer disposed over at least a portion of the adhesive layer, the second layer being permeable to the injection fluid; and
a third layer disposed over the second layer, the third layer being permeable to the injection fluid; and
   wherein the waterproofing article further comprises at least one of the following:
   a) the adhesive layer is disposed over at least 50% of the surface area of the first layer;
   b) the adhesive layer comprises a pressure sensitive adhesive;
   c) the first layer comprises a multilayer film;
   d) the first layer comprises a methane barrier layer; and
   e) the first layer exhibits a maximum or steady-state permeation rate to reagent grade chlorinated hydrocarbons below 10000 μg/cm²/min at a temperature of 60° C. measured according to ASTM F739 Open Loop method.

### BRIEF DESCRIPTION OF THE DRAWINGS

The present disclosure may be better understood, and its numerous features and advantages made apparent to those skilled in the art by referencing the accompanying drawings.

FIG. 1A is a schematic illustration showing a cross-sectional view of a waterproofing article according to an embodiment of the present invention.

FIG. 1B is a schematic illustration showing a cross-sectional view of a waterproofing article according to another embodiment of the present invention.

FIG. 1C is a schematic illustration showing a method of joining adjacent sheets of waterproofing membranes of FIG. 1A according to an embodiment of the present invention.

FIG. 2 is an isometric view of fluid delivery system with interlinking extension.

FIG. 3 is a side view of fluid delivery system installed between rebar matrix and shoring system.

FIG. 4 is a side view of fluid delivery system installed between concrete structure and shoring system.

FIG. 5 is an isometric view of compartmentalized fluid delivery system with fluid dispensing mechanisms attached.

### DETAILED DESCRIPTION

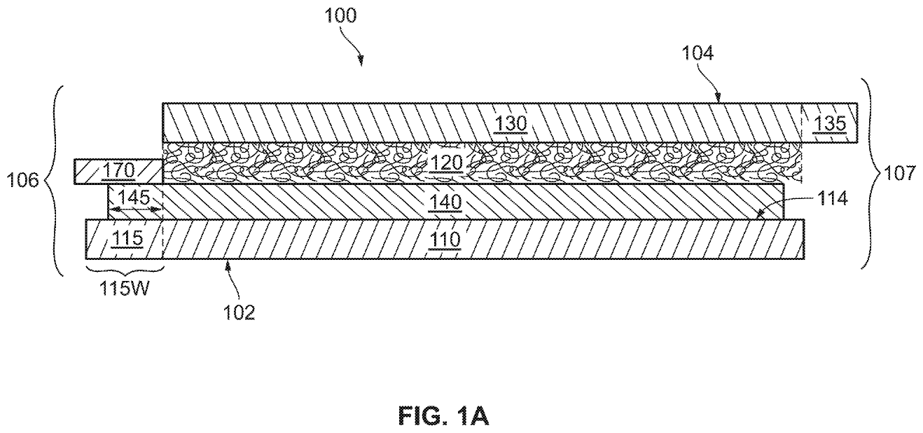

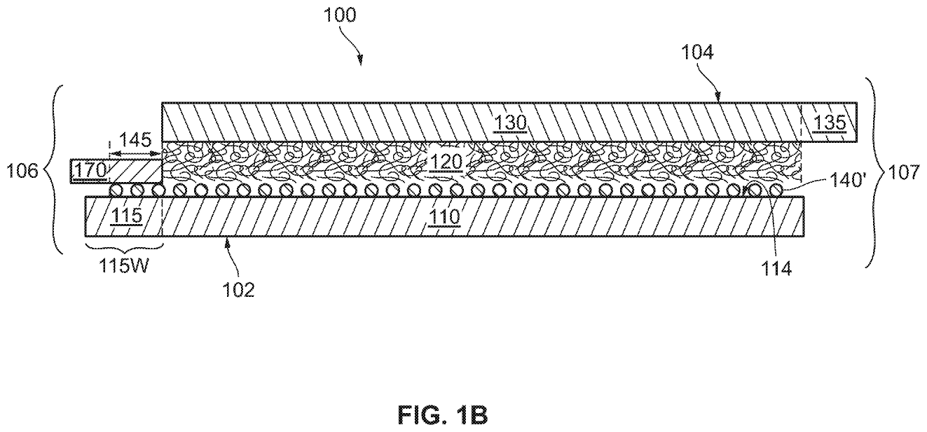

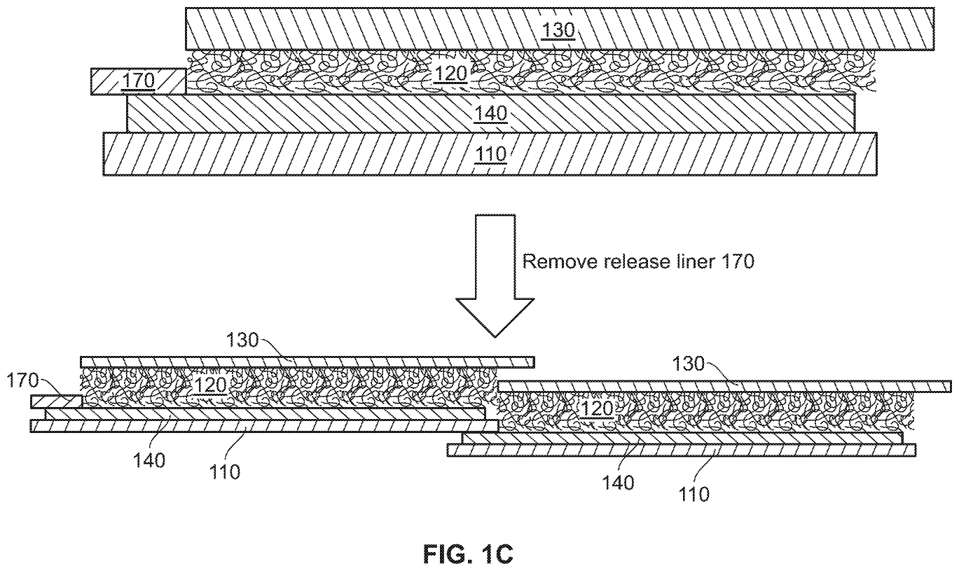

FIG. 1A depicts a schematic illustration of a waterproofing article 100. The waterproofing article 100 is configured to receive an injection fluid and provide waterproofing for a structure. In the preferred embodiment, the waterproofing article 100 comprises a first layer 110, the first layer 110 being impermeable to an injection fluid; an adhesive layer disposed over at least a portion of the first layer 110; a second layer 120 disposed over at least a portion of the adhesive layer, the second layer 120 being permeable to the injection fluid; and a third layer 130 disposed over the second layer 120, the third layer 130 being permeable to the injection fluid.

While the preferred embodiment of the invention consists of three layers joined together, alternate multiple-layer configurations are possible. The waterproofing article 100 can have a first surface 102 on the side of the first layer 110. The waterproofing article 100 can have a second surface 104, on the side of the third layer 130.

The first layer 110 may have a particular structure or composition that may facilitate improved performance or manufacturing of the waterproofing article. In an embodiment, the first layer 110 can be a non-permeable layer that is preferably waterproofing and self-sealing. In an embodiment, the first layer 110 may comprise a polyalkylene terephthalate, a polyolefin, poly(ethylene-co-vinyl alcohol), a thermoplastic polyurethane, a polycarbonate, poly(vinyl chloride), acrylonitrile butadiene styrene, a metal (such as aluminum or an aluminum alloy), asphalt, or a combination thereof.

In an embodiment, the first layer 110 can comprise a multilayer film. In an embodiment, the multilayer film can comprise a polyolefin film disposed over a polyalkylene terephthalate film. In a more particular embodiment, the polyolefin film may comprise polyethylene or polypropylene, and the polyalkylene terephthalate film may comprise polyethylene terephthalate. In an embodiment, the polyolefin film can define the first surface 102 of the waterproofing article 100.

In an embodiment the first layer 110 may have a particular permeability that may facilitate improved performance or manufacturing of the waterproofing article. In an embodiment, the first layer 110 can have a maximum or steady-state permeation rate to reagent grade chlorinated hydrocarbons below 10000 μg/cm²/min at a temperature of 60° C. measured according to ASTM F739 Open Loop method. In an embodiment, the first layer 110 comprises a methane barrier layer. As used herein, methane barrier layer is characterized by having a permeability of less than or equal to 40 mL/day·m²·atm (including zero), when tested according to ASTM D1434.

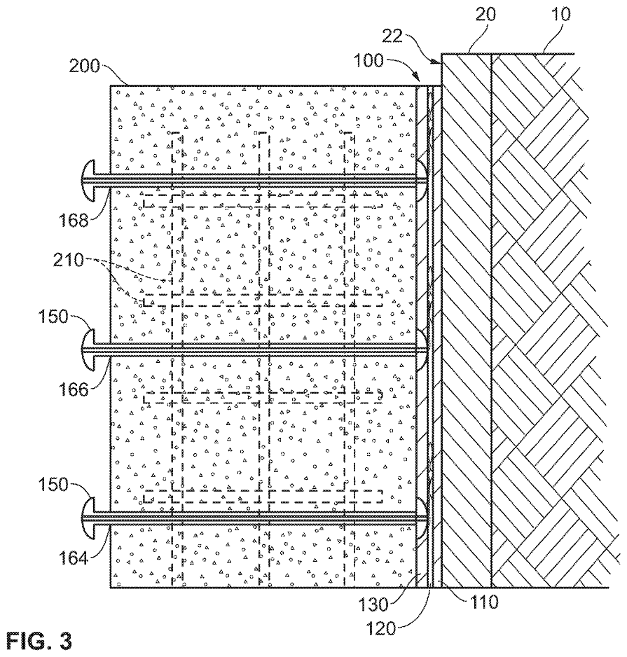

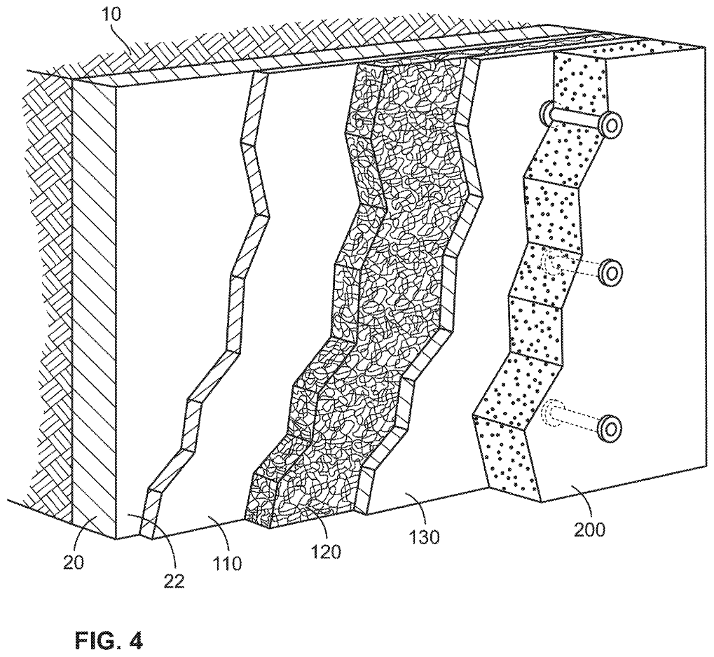

The first layer 110 may have an adhesive layer disposed on a first layer interior surface 114 and an optional additional adhesive layer (not shown) disposed on a first surface 102. The adhesive layer permits joining of adjacent panels of the waterproofing article 100. The additional adhesive layer aids in affixing the waterproofing article 100 to a shoring system 20 (see in FIGS. 3 and 4).

In an embodiment, the adhesive layer may be disposed over a certain amount of the surface area of the interior surface 114 of the first layer 110. In an embodiment, the adhesive layer is disposed over at least 50% of the surface area of the interior side of the first layer or at least 60% or at least 80% or at least 90% or at least 95% or at least 98% or at least 99% of the surface area of the first layer. In an embodiment, the adhesive layer can be a substantially continuous adhesive layer, as shown in FIG. 1A, that covers a majority of the surface area of interior surface 114 of the first layer 110 without being interrupted by spots or potions of interior surface 114 of the first layer 110 without any adhesive. In another embodiment, the waterproofing article, such as those shown in FIG. 1B, includes a discontinuous adhesive layer. A discontinuous adhesive layer may have spots or portions of interior surface 114 of the first layer 110 without any adhesive. It may have a dot or checkerboard pattern of adhesive, such that each dot of the adhesive is substantially bigger than the fastener that can be used to secure the article to a wood lagging or some other structural support. A continuous adhesive layer can provide additional benefits such as improved adhesion between adjacent waterproofing articles 100 forming a waterproofing system and improved adhesion between the second layer 120 and the first layer 110. A continuous adhesive layer can also provide waterproofing or sealing around any items such as fastener that may deliberately penetrate the waterproofing article 100.

In an embodiment, the adhesive layer and/or the additional adhesive layer may include a particular composition that may facilitate improved performance or manufacturing of the waterproofing article. In an embodiment, the first and/or second adhesive layer can comprise a pressure sensitive adhesive. In an embodiment, the first and/or second adhesive layer can comprise a hot melt adhesive. In an embodiment, the adhesive layer can comprise a polyurethane, acrylic, silicone, ethylene-vinyl acetate, polyamide, polyolefin, amorphous poly(alpha-olefin), polybutylene, styrenic block copolymer, natural rubber, atactic polypropylene, solvent-based resin, polymer modified asphalt, natural rubber, or a combination thereof. In a particular embodiment, the adhesive layer and/or the additional adhesive layer can comprise a styrenic block copolymer.

In an embodiment, the second layer 120 may have a particular structure and composition that may facilitate improved performance or manufacturing of the waterproofing article. In an embodiment, the second layer 120 can be a porous structure. The second layer 120 may be sufficiently rigid to maintain a gap between the first layer 110 and the third layer 130. The second layer 120 may be conducive to permitting a free-flowing substance, such as an injection fluid to flow throughout the waterproofing article 100. The second layer 120 may be formed by fibrous material. The second layer 120 may be formed by an open lattice of fibers of sufficient rigidity to maintain the presence of the gap when an inward force is exerted against the waterproofing article 100. The second layer 120 can include a polymer mesh, a woven polymer, or a non-woven polymer. In an embodiment, the second layer 120 can comprise a polyolefin, a nylon, a polyester, acrylonitrile butadiene styrene (ABS), polyvinyl chloride (PVC), high-density polyethylene (HDPE), natural rubber, and nitrile rubber, or a combination thereof. The presence of the second layer 120 permits the channeling of free-flowing substances, such as an injection fluid, through the waterproofing article 100. The second layer 120 provides a space for an injection fluid such as a waterproofing resin, cement, or grout to be received and cured.

In an embodiment, the injection fluid may have a particular composition that may facilitate improved performance or manufacturing of the waterproofing article. In an embodiment, the injection fluid may comprise a liquid, a gas, or a combination thereof. In an embodiment, the injection fluid may comprise a micro-fine cementitious grout, a polyurethane grout, an acrylate grout, an acrylate co-polymer grout, a polymer emulsion, insecticides, mold preventatives, rust retardants, or a combination thereof. The polymer emulsion may comprise styrene butadiene rubber, natural rubber, styrene acrylate, acrylate or a combination thereof.

In an embodiment, the third layer 130 may have a particular structure and composition that may facilitate improved performance or manufacturing of the waterproofing article 100. In an embodiment, the third layer 130 can be semi-permeable. In a preferred embodiment, the third layer 130 can be made of a material suitable for permeating fluids therethrough, while prohibiting passage of concrete or other similar structural construction materials. In an embodiment, the third layer 130 may comprise a permeable textile such as a geotextile. Suitable examples of a permeable geotextile include, but is not limited to, polypropylene, polyethylene, polyamide, polyester, and combinations thereof. Additionally, other materials known in the art may be preferable depending on the application. The third layer 130 may be heat welded or thermally bonded to the second layer. Alternatively, it can be adhered via an adhesive. The third layer 130 may be configured to be attached to a structure. The structure can be formed of structural construction materials such as, but not limited to, concrete, shotcrete, plaster, stoneware, cinderblock, brick, wood, plastic, foam, or a combination thereof. The structure can be a building foundation.

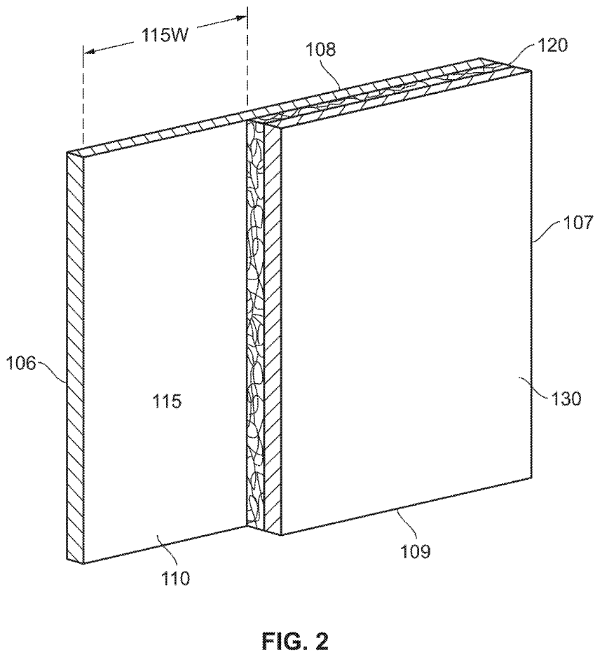

Referring to FIG. 2, the first layer 110, the second layer 120, and the third layer 130 are fixedly attached, with the second layer 120 interposed between the first layer 110 and the third layer 130. The waterproofing article 100 can include a first side 106 and a second side 107 opposite the first side. The waterproofing article 100 can further include a third side 108 extending between the first side 106 and the second side 107 as well as a fourth side 109 extending between the first side 106 and the second side 107 opposite the third side 108. As can be seen in FIG. 2 the first layer 110, the second layer 120, and the third layer 130 are all substantially flush with each other on the on the third side 108 and the fourth side 109.

In an embodiment, the first layer 110 may include a first layer extension 115 that extends past the second layer 120 and the third layer 130, as shown in FIGS. 1A and 2. The first layer extension 115 may be on the first side 106 of the waterproofing article 100. The second layer 120 and the third layer 130 may be substantially flush with each other on the first side 106 of the waterproofing article 100.

In an embodiment, the third layer 130 may include a third layer extension 135 that extends past the second layer 120 and the first layer 110, as shown in FIG. 1A. The third layer extension 135 may be on the second side 107 of the waterproofing article 100. The second layer 120 and the first layer 110 may be substantially flush with each other on the second side 107 of the waterproofing article 100.

In an embodiment, the first layer extension 115 can have a particular first layer extension width, 115W, that may facilitate improved performance and/or manufacturing of the waterproofing article 100. In an embodiment, the first layer extension width 115W may be at least 0.1 inches or at least 0.25 inches or at least 0.5 inches or at least one inch. In another embodiment, the first layer extension width 115W may be no greater than 7 inches, or no greater than 6 inches, or no greater than 5 inches. It will be appreciated that the first layer extension width 115W may be between any of the minimum or maximum values noted above, including for example but not limited to at least 0.1 inches and no greater than 7 inches or at least one inch and no greater than 5 inches.

In an embodiment, the adhesive layer may be disposed over at least a portion of the first layer extension 115. In another embodiment, the adhesive layer may be disposed less than the full width 115W of the first layer extension 115. In yet another embodiment, the adhesive layer may be disposed over substantially the full width 115W of the first layer extension 115. The waterproofing article 100 may further include release liner 170 disposed over the portion 145 of the adhesive layer that is disposed over the first layer extension 115 and the second layer 120 is not disposed over that portion 145 of the adhesive layer.

In the preferred embodiment, as shown in FIGS. 3 and 4, a shoring system 20 is installed to retain earth 10 when a large quantity of soil is excavated. The shoring system 20 includes common shoring techniques such as I-beams with pilings and shotcrete. The waterproofing article 100 is attached to shoring system exterior surface 22. As previously discussed, the waterproofing article 100 can be attached to shoring system exterior surface 22 by applying an adhesive to first surface 102 then applying first surface 102 to shoring system exterior surface 22. Alternatively, the waterproofing article 100 can be attached to shoring system exterior surface 22 by driving nails, or other similar attachment means, through the waterproofing article 100 and into shoring system 20. As noted above, the adhesive layer may provide for additional sealing when items intentionally or otherwise puncture the waterproofing article 100.

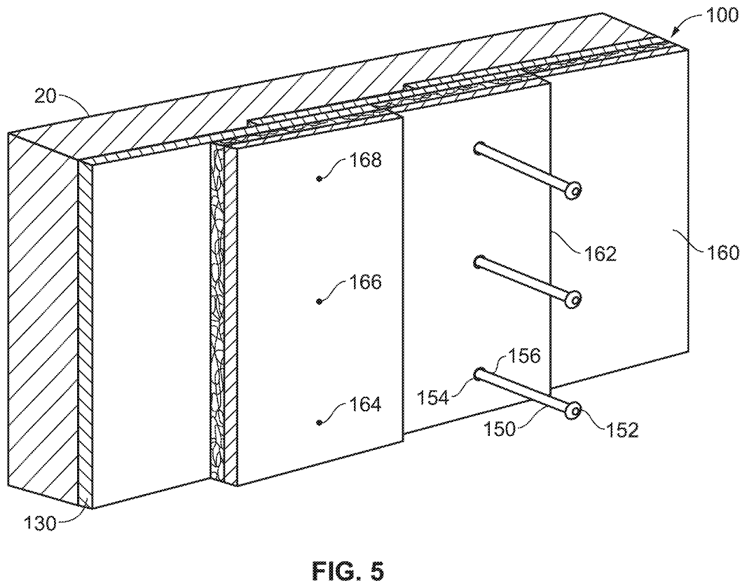

Referring to FIG. 5, the waterproofing article 100 canvases shoring system 20. The waterproofing article 100 can be cut to any size, depending on the application. If a single waterproofing article 100 does not cover the desired area, a plurality of waterproofing articles 100 are used in concert to provide waterproof protection. As previously discussed, the waterproofing article 100 may include first layer extension 115 for reinforcement at the abutment between adjacent waterproofing articles 100. Thus, the first waterproofing article 100 is fixedly attached to shoring system 20, with first layer extension 115 extending outwardly onto shoring system 20. A second waterproofing article 100 overlays first layer extension 115 of the first waterproofing article 100, thereby interlinking the first and the second waterproofing article 100, as shown in FIG. 1C. This process is repeated until the plurality of waterproofing articles 100 blanket shoring system 20. The area of overlap between two adjacent panels of substance delivery system 100 preferably extends vertically. The upper terminal end of the waterproofing article 100, proximate the upper edge of the constructed form (not shown), is sealed with a sealing mechanism 105. The sealing mechanism 105 prevents the injected fluid from being discharged through the top of the waterproofing article 100. The sealing mechanism 105 may be a clamp or other similar clenching device for sealing the upper terminal end of the waterproofing article 100.

Referring to FIG. 5, a division strip 162 can be fixedly attached in a vertical orientation between the junction points of adjacent waterproofing articles 100. In a preferred embodiment the division strip 162 can have an adhesive surface, thereby allowing the division strip 162 to be quickly and safely installed. Alternatively, the division strip 162 may be installed by driving a plurality of nails, or similar attaching means, through the division strip 162. The first layer extension 115 may be of such width as to accommodate the division strip 162 and still permit joining to an adjacent panel of the substance delivery system 100.

The division strip 162 can be preferably comprised of a material that swells upon contact with water. When water interacts with the division strip 162, the division strip 162 outwardly expands, thereby eliminating communication between the abutting waterproofing articles 100. Thus, the division strip 162 compartmentalizes each panel of the substance delivery system 100. Compartmentalization enables selective injection of a fluid or gas into a predetermined the waterproofing article 100. Alternatively, division strip 162 is formed from a non-swelling material. When division strip 162 is non-swelling, the structural construction material 200 forms around division strip 162, thereby filling in any voids and forming a seal between adjacent waterproofing articles 100.

In an embodiment, a system of waterproofing articles 100 may exhibit a particular adhesion (as measured according to by ASTM D1876) between a first and second waterproofing article. In an embodiment, the adhesion between a first and second waterproofing article may be at least 3 pli, or at least 4 pli, or at least 5 pli by ASTM D1876.

Referring to FIGS. 3 and 5, a waterproofing system can include at least one piping 150 engagedly attached to the waterproofing article 100 as described herein and above. The piping 150 can be tubular, with an inlet 152, an outlet 154, and a cylinder 156 extending therebetween. A plurality of teeth (not shown) outwardly can extend from the outlet 154 and engage the first layer 130 as to permit injection of fluid into the first layer 130 through to the intermediate layer 120. Cylinder 156 can extend through rebar matrix 210, with inlet 152 terminating exterior the structural construction material form (not shown). Cylinder 156 can be secured to rebar matrix 210 through ties, clamps, or other similar means of attachment. The number of pipings 150 necessary is dependent on the size of chamber 160. In the preferred embodiment of the invention, piping 150 should be positioned at lower point 164, mid-point 166, and upper point 168.

In the preferred embodiment depicted in FIG. 3, a structural construction material 200 is inserted into form (not shown). The structural construction material 200 can be concrete, shotcrete, plaster, stoneware, cinderblock, brick, wood, plastic, foam, or a combination thereof. The first layer 110 of the waterproofing article 100 provides the primary waterproof defense. If it is determined that the first layer 110 has been punctured or has failed, resulting in water leaking to structural construction material 200, an injection fluid can be pumped to the waterproofing article 100 located proximate the leak. Alternatively, the injection fluid may be introduced during installation of the waterproofing article 100. The injection fluid can be a waterproofing resin, or a cementitious or a chemical grout, that may cure and harden and provide additional waterproofing or other protection. The injection fluid can be introduced to such the waterproofing article 100 via piping 150 in an upward progression, wherein the free flowing substance is controllably introduced to lower point 164 of panel of the waterproofing article 100, then to mid-point 166 of panel of the waterproofing article 100, and then to upper point 168 of panel of the waterproofing article 100. A dye may be added to the injection fluid, allowing for a visual determination of when to cease pumping injection fluid to panel of the waterproofing article 100. When the dye in the injection fluid leaks out of structural construction material 200, thereby indicating that the waterproofing article 100 is fully impregnated, pumping is ceased.

The second layer 120 and the third layer 130 permeate the injection fluid into the space between the third layer 130 and structural construction material 200. When the injection fluid is a hydrophilic liquid, the injection fluid interacts with any water present, thereby causing the injection fluid to expand and become impermeable, creating an impenetrable waterproof layer. Thus, a secondary waterproof barrier can be created if a failure occurs in the first layer 110.

In an embodiment, the waterproofing article 100 may exhibit a particular adhesion (as measured according to ASTM D1876) between the cured or hardened injection fluid and the first layer that may facilitate improved performance or manufacturing of the waterproofing article. In an embodiment, the adhesion between the injection fluid and the first layer may be at least 0.5 pli or at least 1 pli or at least 1.5 pli by ASTM D1876.

Alternatively, different free flowing substances may be introduced to the waterproofing article 100, depending on the situation. If the integrity of structural construction material 200 is compromised, a resin for strengthening structural construction material 200 can be injected into the waterproofing article 100 to repair structural construction material 200. Alternatively, a gas may be injected into the waterproofing article 100 for providing mold protection, rust retardation, delivering an insecticide, or other similar purposes.

In a separate and distinct embodiment of the invention, the second layer 120 may be completely replaced with the third layer 130.

In a separate and distinct embodiment of the invention, the waterproofing article 100 can be directly attached to the earth, such as in a tunnel or mine. In this embodiment, the waterproofing article 100 can be inversely installed on tunnel surface (not shown). The third layer 130 faces tunnel surface and the first layer 110 inwardly faces tunnel space. The waterproofing article 100 can be fixedly attached by applying an adhesive to the third layer 130, driving nails through the waterproofing article 100, or similar attaching means known in the art. The waterproofing article 100 is installed in vertical segments, similar to the method described above for the preferred embodiment. However, the plurality of piping 150 is not necessary in the alternative embodiment.

Once the waterproofing article 100 is installed on tunnel surface, the structural construction material 200 can be installed directly onto the first layer 110.

In the alternative embodiment (not shown). Should a failure occur in the waterproofing article 100, an operator can drill a plurality of holes through the structural construction material 200, ceasing when the first layer 110 is penetrated. Such holes would provide fluid access to the second layer 120. An injection fluid (not shown) would then be pumped through the holes, thereby introducing the fluid substance to the second layer 120. The second layer 120 channels the fluid substance throughout substance delivery system 100, permitting the third layer 130 to permeate the injection fluid therethrough.

### EMBODIMENTS

### Embodiment

### 1.

A waterproofing article, comprising:
a first layer, the first layer being impermeable to an injection fluid;
an adhesive layer disposed over at least a portion of the first layer;
a second layer disposed over at least a portion of the adhesive layer, the second layer being permeable to the injection fluid; and
a third layer disposed over the second layer, the third layer being permeable to the injection fluid; and
wherein the waterproofing article further comprises at least one of the following:
a) the adhesive layer is disposed over at least 50% of the surface area of the first layer;
b) the adhesive layer comprises a pressure sensitive adhesive;
c) the first layer comprises a multilayer film;
d) the first layer comprises a methane barrier layer; and
e) the first layer exhibits a maximum or steady-state permeation rate to reagent grade chlorinated hydrocarbons below 10000 μg/cm²/min at a temperature of 60° C. measured according to ASTM F739 Open Loop method.

### Embodiment 2

The waterproofing article according to Embodiment 1, wherein the adhesive layer is disposed over at least 50% or at least 60% or at least 70% or at least 80% or at least 90% or at least 95% or at least 98% or at least 99% of the surface area of the first layer.

### Embodiment 3

The waterproofing article according to Embodiment 1 or Embodiment 2, wherein the adhesive layer comprises a continuous adhesive layer.

### Embodiment 4

The waterproofing article according to any one of Embodiments 1-3, wherein the waterproofing article has a first surface on a side of the first layer opposite adhesive layer and a second surface on a side of the third layer opposite the second layer.

### Embodiment 5

The waterproofing article according to any one of Embodiments 1-4, wherein the adhesive layer comprises a pressure sensitive adhesive.

### Embodiment 6

The waterproofing article according to any one of Embodiments 1-5, wherein the adhesive layer comprises a hot melt pressure sensitive adhesive.

### Embodiment 7

The waterproofing article according to any one of Embodiments 1-6, wherein the adhesive layer comprises a polyurethane, acrylic, silicone, ethylene-vinyl acetate, polyamide, polyolefin, amorphous poly(alpha-olefin), polybutylene, styrenic block copolymer, natural rubber, atactic polypropylene, solvent-based resin, polymer modified asphalt, natural rubber, or a combination thereof.

### Embodiment 8

The waterproofing article according to any one of Embodiments 1-7, wherein the adhesive layer comprises a styrenic block copolymer.

### Embodiment 9

The waterproofing article according to any one of Embodiments 1-8, further comprising an additional adhesive layer disposed on the first layer opposite the adhesive layer.

### Embodiment 10

The waterproofing article according to any one of Embodiments 1-9, wherein the first layer comprises a multilayer film.

### Embodiment 11

The waterproofing article according to any one of Embodiments 1-10, wherein the first layer comprises a methane barrier layer.

### Embodiment 12

The waterproofing article according to any one of Embodiments 1-11, wherein the first layer exhibits a maximum or steady-state permeation rate to reagent grade chlorinated hydrocarbons below 10000 μg/cm²/min at a temperature of 60° C. measured according to ASTM F739 Open Loop method.

### Embodiment 13

The waterproofing article according to any one of Embodiments 1-12, wherein the first layer comprises a polyalkylene terephthalate, a polyolefin, poly(ethylene-co-vinyl alcohol), a thermoplastic polyurethane, a polycarbonate, poly(vinyl chloride), acrylonitrile butadiene styrene, a metal (such as aluminum or an aluminum alloy), asphalt, or a combination thereof.

### Embodiment 14

The waterproofing article according to any one of Embodiments 1-13, wherein the first layer comprises a polyolefin film disposed over a polyalkylene terephthalate film.

### Embodiment 15

The waterproofing article according to Embodiment 14, wherein the polyolefin layer comprises polyethylene or polypropylene, and the polyalkylene terephthalate layer comprises polyethylene terephthalate.

### Embodiment 16

The waterproofing article according to Embodiment 14 or Embodiment 15, wherein the polyolefin layer defines a first surface of the waterproofing article.

### Embodiment 17

The waterproofing article according to any one of Embodiments 1-16, wherein the third layer is impermeable to structural construction materials.

### Embodiment 18

The waterproofing article according to any one of Embodiments 1-17, wherein structural construction materials comprise concrete, shotcrete, plaster, stoneware, cinderblock, brick, wood, plastic, foam, or a combination thereof.

### Embodiment 19

The waterproofing article according to any one of Embodiments 1-18, wherein the third layer comprises a permeable textile.

### Embodiment 20

The waterproofing article according to Embodiment 19, wherein the permeable textile comprises a geotextile.

### Embodiment 21

The waterproofing article according to Embodiment 20, wherein the geotextile comprises polypropylene, polyethylene, polyamide, polyester, or any combination thereof.

### Embodiment 22

The waterproofing article according to any one of Embodiments 1-21, wherein the third layer is configured to be attached to a structure formed by one or more structural construction materials.

### Embodiment 23

The waterproofing article according to Embodiment 22, wherein the structure comprises concrete, shotcrete, plaster, stoneware, cinderblock, brick, wood, plastic, foam, or a combination thereof.

### Embodiment 24

The waterproofing article according to Embodiment 22 or Embodiment 23, wherein the waterproofing article is configured to receive the injection fluid through the structure and the first layer of the waterproofing article.

### Embodiment 25

The waterproofing article according to any one of Embodiments 1-24, wherein the injection fluid comprises a waterproofing resin, a cementitious or a chemical grout, an insecticide, a mold preventative, a rust retardant, or a combination thereof.

### Embodiment 26

The waterproofing article according to any one of Embodiments 1-25, wherein the injection fluid comprises a micro-fine cementitious grout, a polyurethane grout, an acrylate grout, an acrylate co-polymer grout, a polymer emulsion, or a combination thereof.

### Embodiment 27

The waterproofing article according to Embodiment 26, wherein the polymer emulsion comprises styrene butadiene rubber, natural rubber, styrene acrylate, acrylate or a combination thereof.

### Embodiment 28

The waterproofing article according to any one of Embodiments 1-27, wherein the second layer comprises a porous structure.

### Embodiment 29

The waterproofing article according to any one of Embodiments 1-28, wherein the second layer comprises a polyolefin, a nylon, a polyester, acrylonitrile butadiene styrene, polyvinyl chloride, high-density polyethylene, natural rubber and nitrile rubber, or a combination thereof.

### Embodiment 30

The waterproofing article according to any one of Embodiments 1-29, wherein the second layer comprises a fibrous material.

### Embodiment 31

The waterproofing article according to any one of Embodiments 1-30, wherein the second layer comprises an open lattice of fibers.

### Embodiment 32

The waterproofing article according to any one of Embodiments 1-31, wherein the second layer comprises a polymer mesh, a woven polymer, or a nonwoven polymer.

### Embodiment 33

The waterproofing article according to Embodiment 32, wherein the polymer comprises polyolefin.

### Embodiment 34

The waterproofing article according to any one of Embodiments 1-33, wherein the waterproofing article comprises a first side and a second side opposite the first side.

### Embodiment 35

The waterproofing article according to Embodiment 34, wherein the second layer and the third layer are substantially flush with each other on the first side.

### Embodiment 36

The waterproofing article according to Embodiments 34 or Embodiment 35, wherein the first layer further comprises a first layer extension such that a portion of the first layer extends past the second and third layers, wherein the first layer extension is on the first side of the waterproofing article.

### Embodiment 37

The waterproofing article according to Embodiment 36, wherein the first layer extension comprises a width of at least 0.1 inches or at least 0.25 inches or at least 0.5 inches or at least one inch.

### Embodiment 38

The waterproofing article according to Embodiment 36 or Embodiment 37, wherein the first layer extension comprises a width of no greater than 7 inches, or no greater than 6 inches, or no greater than 5 inches.

### Embodiment 39

The waterproofing article according to any one of Embodiments 36-38, wherein the adhesive layer extends over the first layer extension.

### Embodiment 40

The waterproofing article according to Embodiment 39, wherein the adhesive layer extends less than the full width of the first layer extension.

### Embodiment 41

The waterproofing article according to Embodiment 39 or Embodiment 40, further comprising a release liner disposed over the portion of the adhesive layer that extends over the first layer extension.

### Embodiment 42

The waterproofing article according to Embodiment 41, wherein the release liner comprises a silicone coated polypropylene.

### Embodiment 43

The waterproofing article according to any one of Embodiments 34-42, wherein second layer and first layer are substantially flush with each other on the second side.

### Embodiment 44

The waterproofing article according to any one of Embodiments 34-43, wherein the third layer further comprises a third layer extension such that a portion of the third layer extends past the second and first layers, wherein the third layer extension is on the second side of the waterproofing article.

### Embodiment 45

The waterproofing article according to any one of Embodiments 34-44, wherein the waterproofing article further comprises a third side extending between the first side and the second side as well as a fourth side extending between the first side and the second side opposite the third side.

### Embodiment 46

The waterproofing article according to Embodiment 45, wherein the first layer, second layer, and third layer are all flush with each other on the on the third side and the fourth side.

### Embodiment 47

The waterproofing article according to any one of Embodiments 1-46, wherein the waterproofing article exhibits an adhesion between the injection fluid and the first layer of at least 0.5 pli or at least 1 pli or at least 1.5 pli as measured by ASTM D1876.

### Embodiment 48

A system comprising, a first waterproofing article according to any of Embodiments 1 to 47, and a second article according to any of Embodiments 1 to 47, wherein the first layer of the second waterproofing article is adhered to the first layer extension of the first waterproofing article via the adhesive layer of the first waterproofing article.

### Embodiment 49

The system according to Embodiment 48, comprising an adhesion between the first article and the second article of at least 3 pli, or at least 4 pli, or at least 5 pli.

### Embodiment 50

A system comprising the waterproofing article of Embodiment 22 attached to the structure, and at least one piping that passes through said structure, wherein the at least one piping is configured to deliver the injection fluid to the second layer.

### Embodiment 51

The system according to Embodiment 50, wherein the at least one piping comprises an inlet and an outlet on opposite end of the piping, wherein the inlet extends beyond an exterior surface of the structure and the outlet is positioned to deliver the injection fluid to the second layer.

### Embodiment 52

The system according to Embodiment 50 or Embodiment 51, wherein:
said at least one piping comprises a first piping;
said third layer having a third layer bottom-edge;
said first piping located proximate said third layer bottom-edge;
said third layer having a top-edge; and
a second piping being located proximate to said third layer top-edge.

### Embodiment 53

The system according to Embodiment 52, further comprising
a third piping located between said third layer bottom-edge and said third layer top-edge.

### Embodiment 54

A method of waterproofing a structure:
affixing a first waterproofing article according to any of Embodiments 1 to 47, to a shoring structure or an excavated surface.

### Embodiment 55

The method according to Embodiment 54, wherein the first layer of said first waterproofing article is in contact with the shoring structure or excavated surface.

### Embodiment 56

The method according to Embodiment 54 or Embodiment 55, wherein the first waterproofing article comprises a waterproofing article according to Embodiment 1 to 47, further comprising affixing a second waterproofing article according to any of Embodiments 1 to 47, to the shoring structure or excavated surface, wherein a portion of the second waterproofing article overlaps with a portion of the first waterproofing article such that the first layer of the second waterproofing article is adhered to the first layer extension of the first waterproofing article via the adhesive layer of the first waterproofing article.

### Embodiment 57

The method according to any one of Embodiments 54-56, further comprising fixedly attaching at least one piping to said third layer of said first waterproofing article said at least one piping configured to permit injection of an injection fluid into the second layer.

### Embodiment 58

The method according to Embodiment 57, wherein the method further comprises selectively introducing said injection fluid to said first waterproofing article through said at least one piping.

### Embodiment 59

The method according to Embodiment 58, wherein said selectively introducing said injection fluid step further comprises: terminating said introduction of said injection fluid when said waterproofing article is fully impregnated.

### Embodiment 60

The method according to any one of Embodiments 57-59, wherein said fixedly attaching said at least one piping step further comprises:
inserting a first piping into a lower point of said first waterproofing article;
inserting a second piping into a midpoint of said first waterproofing article; and
inserting a third piping into an upper point of said first waterproofing article.

### Embodiment 61

The method according to any one of Embodiments 57-60, wherein the piping comprises an inlet and an outlet on opposite ends of the piping, wherein the inlet extends beyond an exterior surface of the structure and the outlet is positioned to deliver the injection fluid to the second layer.

### Embodiment 62

The method according to any one of Embodiments 57-61, further comprising constructing a structural construction materials form against said third side of said first waterproofing article, so said at least one piping extends through said structural construction materials form.

### Embodiment 63

The method according to Embodiment 62, further comprising depositing structural construction materials over said first waterproofing article.

### Embodiment 64

The method according to any one of Embodiments 54-63, said attaching step further comprising:
applying an adhesive to at least one side of said first waterproofing article.

### Embodiment 65

The method according to any one of Embodiments 54-64, said attaching step further comprising:
driving a plurality of nails through said first waterproofing article.

### Embodiment 66

The method according to any one of Embodiments 54-65, further comprising:
determining an area of failure in the waterproofing article;
drilling at least one hole proximate said area of failure; and
injecting an injection fluid into the waterproofing article through said at least one hole.

### EXAMPLES

### Example 1: Preparing a Waterproofing Article

such as a waterproofing membrane

A layer of hot melt pressure sensitive adhesive comprising a styrenic block copolymer-based adhesive, about 0.5 mm thick, was applied to the PET surface of a first layer comprising a dual layer thermoplastic film of HDPE and PET, about 0.25 mm thick. A prefabricated second and third layer component comprising a polypropylene mesh heat welded to a geotextile, and having a total thickness of about 3 mm, was laminated to the hot melt pressure sensitive adhesive, leaving about 2 to 3 inches of hot melt pressure sensitive adhesive, a styrenic block copolymer, exposed on one edge of the first layer. Total membrane width was about 4 ft. Release liner, a silicone coated polypropylene, was laminated to the remaining exposed portion of hot melt pressure sensitive adhesive.

### Example 2: Preparing a Sample for Grout Adhesion to 1^{st} Layer Test

Activated injection fluid comprising a two-component reactive acrylic grout was applied directly to the hot melt pressure sensitive adhesive layer and allowed to cure. The test sample did not have the second and/or the third layer laminated to the adhesive layer.

Adhesion between the cured injection fluid and the first layer was measured to be 2.49±0.52 pli, according to ASTM D1876.

### Example 3: Preparing a Sample of Waterproofing Article for Lap Adhesion Test

Lap adhesion samples were prepared by removing release liner from one of two prepared waterproofing articles of Example No. 1 and placing the first surface of the first layer of the second waterproofing article on the exposed hot melt pressure sensitive adhesive.

Adhesion between two waterproofing articles was measured to be 6.24±1.2 pli, according to ASTM D1876.

What is claimed is:

1. A waterproofing article, comprising:
a first layer, the first layer being impermeable to an injection fluid;
an adhesive layer disposed over at least a portion of the first layer;
a second layer disposed over at least a portion of the adhesive layer, the second layer being permeable to the injection fluid; and
a third layer disposed over the second layer, the third layer being permeable to the injection fluid; and
wherein the waterproofing article further comprises at least one of the following:
a) the adhesive layer is disposed over at least 50% of the surface area of the first layer;
b) the adhesive layer comprises a pressure sensitive adhesive;
c) the first layer comprises a multilayer film;
d) the first layer comprises a methane barrier layer; and
e) the first layer exhibits a maximum or steady-state permeation rate to reagent grade chlorinated hydrocarbons below 10000 μg/cm²/min at a temperature of 60° C. measured according to ASTM F739 Open Loop method.

2. The waterproofing article of claim 1, wherein the adhesive layer comprises a hot melt pressure sensitive adhesive.

3. The waterproofing article of claim 1, wherein the adhesive layer comprises a polyurethane, acrylic, silicone, ethylene-vinyl acetate, polyamide, polyolefin, amorphous poly(alpha-olefin), polybutylene, styrenic block copolymer, natural rubber, atactic polypropylene, solvent-based resin, polymer modified asphalt, natural rubber, or a combination thereof.

4. The waterproofing article of claim 1, wherein the first layer comprises a multilayer film.

5. The waterproofing article of claim 1, wherein the first layer comprises a methane barrier layer.

6. The waterproofing article of claim 1, wherein the first layer exhibits a maximum or steady-state permeation rate to reagent grade chlorinated hydrocarbons below 10000 μg/cm²/min at a temperature of 60° C. measured according to ASTM F739 Open Loop method.

7. The waterproofing article of claim 1, wherein the first layer comprises a polyalkylene terephthalate, a polyolefin, poly(ethylene-co-vinyl alcohol), a thermoplastic polyurethane, a polycarbonate, poly(vinyl chloride), acrylonitrile butadiene styrene, a metal (such as aluminum or an aluminum alloy), asphalt, or a combination thereof.

8. The waterproofing article of claim 1, wherein the first layer comprises a polyolefin film disposed over a polyalkylene terephthalate film.

9. The waterproofing article of claim 1, wherein the third layer is impermeable to structural construction materials.

10. The waterproofing article of claim 1, wherein structural construction materials comprise concrete, shotcrete, plaster, stoneware, cinderblock, brick, wood, plastic, foam, or a combination thereof.

11. The waterproofing article of claim 1, wherein the third layer is configured to be attached to a structure formed by one or more structural construction materials.

12. The waterproofing article of claim 1, wherein the injection fluid comprises a waterproofing resin, a cementitious or a chemical grout, an insecticide, a mold preventative, a rust retardant, or a combination thereof.

13. The waterproofing article of claim 1, wherein the second layer comprises a porous structure.

14. The waterproofing article of claim 1, wherein the second layer comprises a polyolefin, a nylon, a polyester, acrylonitrile butadiene styrene, polyvinyl chloride, high-density polyethylene, natural rubber and nitrile rubber, or a combination thereof.

15. The waterproofing article of claim 1, wherein the first layer further comprises a first layer extension such that a portion of the first layer extends past the second and third layers.

16. The waterproofing article of claim 15, wherein the adhesive layer extends over at least a portion of the first layer extension.

17. The waterproofing article of claim 16, wherein the third layer further comprises a third layer extension such that a portion of the third layer extends past a second and first layers, wherein the third layer extension is on the second side of the waterproofing article.

18. The waterproofing article of claim 17, wherein the waterproofing article further comprises a third side extending between the first side and the second side as well as a fourth side extending between the first side and the second side opposite the third side.

19. The waterproofing article of claim 18, wherein the first layer, second layer, and third layer are all flush with each other on the third side and the fourth side.

20. The waterproofing article of claim 1, wherein the waterproofing article exhibits an adhesion between the injection fluid and the first layer of at least 0.5 pli or at least 1 pli as measured by ASTM D1876.

21. A system comprising, a first waterproofing article according to claim 1, and a second article according to claim 1, wherein the first layer of the second waterproofing article is adhered to the first layer extension of the first waterproofing article via the adhesive layer of the first waterproofing article.

22. The system according to claim 20, comprising an adhesion between the first article and the second article of at least 3 pli.

23. A system comprising the waterproofing article according to claim 11 attached to the structure, and at least one piping that passes through said structure, wherein the at least one piping is configured to deliver the injection fluid to the second layer.

24. A method of waterproofing a structure:
affixing a first waterproofing article according to claim 1, to a shoring structure or an excavated surface.

25. The method according to claim 24, further comprising affixing a second waterproofing article to the shoring structure or excavated surface, wherein a portion of the second waterproofing article overlaps with a portion of the first waterproofing article such that the first layer of the second waterproofing article is adhered to the first layer extension of the first waterproofing article via the adhesive layer of the first waterproofing article.

26. The method of claim 24, further comprising fixedly attaching at least one piping to said third layer of said first waterproofing article, wherein said at least one piping is configured to permit injection of an injection fluid into the second layer.

27. The method of claim 24, further comprising constructing a structure formed of structural construction materials against said third side of said first waterproofing article, so said at least one piping extends through said structure.

28. The method of claim 27, further comprising depositing structural construction materials over said first waterproofing article.
